(19) United States
(12) Patent Application Publication
(10) Pub. No.: US 2026/0320303 A1
(43) Pub. Date: Oct. 15, 2026

(54) INFRASTRUCTURE AND SOLUTION DESIGN BY LLM WITH VARIABLE GRAPH SYNTAX

(71) Applicant: ORACLE INTERNATIONAL CORPORATION, Redwood Shores, CA (US)

(72) Inventors: Paul Gregory GREENSTEIN, Hopkinton, MA (US); Zbigniew HOLKA, Solihull (GB)

(21) Appl. No.: 19/179,816

(22) Filed: Apr. 15, 2025

(51) Int. Cl. G06F 40/40

(52) U.S. Cl. CPC G06F 40/40

(57) ABSTRACT

Systems, methods, and other embodiments associated with design of infrastructures and other solutions by LLM using a variable syntax for graphs are described. In one embodiment, a method includes accessing requirements for a solution that are in human language. The method includes generating a prompt based at least in part on the requirements. The prompt is configured to cause a large language model to generate a solution topology in a graph representation language. The graph representation language may vary in syntax in response to a change to the requirements. And, the method includes, in response to the prompt, generating the graph representation language, and the solution topology in the graph representation language with the large language model.

### BACKGROUND

Cloud platforms have become popular tools for hosting software applications due to their adaptability, scalability, and accessibility. While the computing environment of a cloud platform is largely virtualized, clients of the cloud platform are tasked with the planning and configuration of physical infrastructure that executes the client's software applications. Designs for logical and physical infrastructure may be expressed as graphs or topologies written in code of a graph representation language.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1A illustrates one embodiment of a variable GRL generation system that is associated with design of infrastructures and other solutions by LLM using a variable syntax for graphs.

FIG. 1B illustrates one embodiment of a variable GRL infrastructure design system that is associated with design of infrastructures and other solutions by LLM using a variable syntax for graphs.

FIG. 2A illustrates one embodiment of a variable GRL generation method that is associated with design of infrastructures and other solutions by LLM using a variable syntax for graphs.

FIG. 2B illustrates one embodiment of a variable GRL infrastructure design method that is associated with design of infrastructures and other solutions by LLM using a variable syntax for graphs.

FIG. 3 illustrates an embodiment of a computing system configured with the example systems and/or methods disclosed.

### DETAILED DESCRIPTION

Systems, methods, and other embodiments are described herein that provide design of infrastructures and other solutions by LLM (Large Language Model) using a variable syntax for graphs. In one embodiment, a GRL (graph representation language) generation system uses an LLM to generate a GRL that is specific to a particular solution, based on human language requirements for the solution.

In one embodiment, the variable GRL generation system uses a human language description of technical requirements for a solution as the basis for LLM generation of both a topology representation of the solution and a GRL for writing the topology. The generated GRL is tailored specifically to represent entities and relationships that appear in the requirements while leaving out representations of entities and relationships that do not appear in the requirements. Therefore, the syntax of the generated GRL may vary from one set of requirements to another. Advantageously, this variably-tailored GRL yields a compact, resource-efficient topology representation of the solution. In one embodiment, the variable GRL generation system improves over static GRLs, in which syntax for all possible nodes, edges, properties, graph structure, and/or labels/tags needs to be included in order to represent various topologies.

### Definitions

As used herein, “human language” refers to natural, everyday language used by people to communicate, including written text or spoken dictation that is used to express infrastructure requirements for compute infrastructure. Human language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a changed infrastructure requirement) is “in human language” where the electronic data expresses, records, defines, stores, or otherwise represents textual (written) or vocal (spoken) human language.

As used herein, the term “solution” refers to a configuration of physical apparatuses, components, circuits, or other hardware to implement particular operations. For example, a solution might be compute infrastructure configured to perform particular information technology operations. Or, for example, a solution might be a collection of machines configured to perform particular operations to produce a product, such as assembly lines, plant layout, chemical processing, or resource extraction equipment. Or for example, a solution might be a particular distribution grid for a utility (e.g., water, electric, and gas). A solution may also include or be fully comprised of software components.

As used herein, the term “solution topology” refers to a graph that represents an architecture of a solution. The term “graph” as used herein may be understood to include: (1) a collection of tokens (such as text tokens) that is translatable to a pictorial or diagrammatic display of entities (nodes) and relationships (edges) of a solution; as well as (2) a pictorial or diagrammatic display of entities and relationships of the solution. A graph might further include properties of the entities and relationships. A graph might be stored as a data structure such as a property graph database. As used herein, the term “infrastructure topology” or “compute infrastructure topology” refers to a particular type of solution topology that represents an architecture of a compute infrastructure, and which describes various logical or physical elements and relationships that deliver an information technology solution.

As used herein, the term “logical solution topology” or “LST” refers to a graph that lays out the relationships and interactions (edges) between different functional elements or components (nodes) of a solution without specifying actual physical devices and connections involved in implementing the solution. The LST outlines logical structure and behavior of the architecture of a solution, independent of underlying real-world implementation. As used herein, the term “logical infrastructure topology” or “LIT” refers to a particular type of LST that shows the relationships and interactions between functional elements or components of a compute infrastructure.

As used herein, the term “physical solution topology” or “PST” refers to a graph that represents a concrete, real-world implementation of the architecture of a solution, specifying the actual physical devices (nodes) and connections (edges) that implement the solution architecture. For example, a PST may be a graph of the physical devices and physical connections that realize a solution described by an LST. As used herein, the term “Physical infrastructure topology” or “PIT” refers to a particular type of PST that shows configurations of specific hardware, networks, storage, and other physical elements that realize a compute infrastructure. For example, a PIT may specify servers, routers, switches, IP address ranges, and the physical connections between them.

As used herein, the terms “compute infrastructure” and “computing infrastructure” (occasionally referred to herein simply as “infrastructure” for short) refers to a collection of hardware, software, networks, facilities, and related services that deliver information technology operations.

As used herein, the term “requirements” refers to a human language description of features or functions of a solution. The requirements detail what the solution is to accomplish. The requirements may include functional requirements: requirements that describe what functions, behaviors, actions, or tasks the solution is to perform. And, the requirements may include non-functional requirements, such performance criteria (such as response time, sustained volume, pace, etc.), operational constraints (e.g., availability, reliability, disaster recovery), technological constraints (e.g., standards compliance, desired technologies or products), and quality attributes (e.g., maximum tolerable defect rate and maintainability). In one embodiment, functional requirements alone are considered for generation of a LST. In one embodiment, non-functional requirements may be disregarded during generation of a LST, and are considered for generation of a PST.

No action or function described or claimed herein is performed by the human mind. An interpretation that any action or function can be performed in the human mind is inconsistent with and contrary to this disclosure.

### Example GRL Generation System

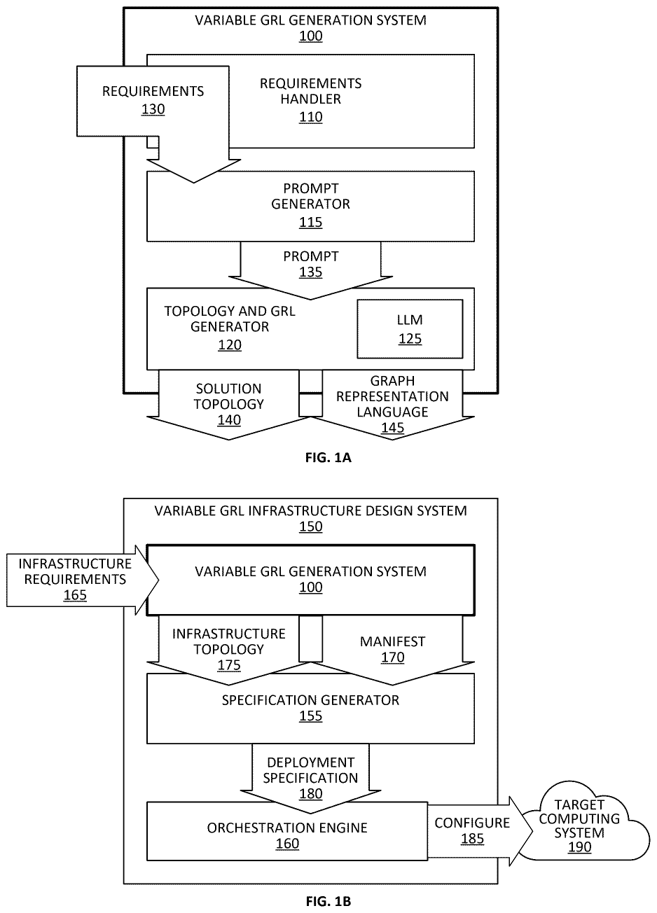

FIG. 1A illustrates one embodiment of a variable GRL generation system 100 that is associated with design of infrastructures and other solutions by LLM using a variable syntax for graphs. In one embodiment, variable GRL generation system 100 generates a graph (topology) for a solution described in human language requirements using a GRL generated from the requirements themselves. Variable GRL generation system 100 has various components, including a requirements handler 110, a prompt generator 115, and a topology and GRL generator 120.

In one embodiment, requirements handler 110 is configured to access requirements 130 for a solution that are in human language. In one embodiment, prompt generator 115 is configured to generate a prompt 135 based at least in part on the requirements 130. The prompt 135 is configured to cause a large language model (LLM) 125 to generate a solution topology 140 in a graph representation language 145 that is derived from the requirements, and that varies in syntax in response to a change to the requirements. In one embodiment, topology and GRL generator 120 is configured to, in response to the prompt, generate with the large language model (1) the graph representation language 145, and (2) the solution topology 140 in the graph representation language 145.

In one embodiment, to clarify the above, a solution topology (graph) is derived from the requirements 130. The syntax of the graph representation language is predefined, but the language of the graph representation language is derived based on the graph in addition to the syntax, since the language must be capable of describing the graph. Requirements alone may not contain sufficient information to derive a graph representation language. So, a graph representation language is derived from the requirements, because it is derived from the topology, which is derived from the requirements.

Referring now to FIG. 1B, in one embodiment, variable GRL generation system 100 is used in a variable GRL infrastructure design system 150 for generation and deployment of compute infrastructure from infrastructure requirements. To the components of variable GRL generation system 100, variable GRL infrastructure design system 150 adds a specification generator 155 and an orchestration engine 160.

Requirements handler 110 is configured to access infrastructure requirements 165. (Infrastructure requirements 165 are human-language requirements 130 that describe a compute infrastructure). Prompt generator 115 is configured to generate prompt 135 to be configured to cause LLM 125 to generate infrastructure topology 175 in the graph representation language 145. In response to prompt 135, variable GRL generation system 100 is configured to generate: (1) a manifest 170 that defines the graph representation language 145 created based on the infrastructure requirements 165; and (2) an infrastructure topology 175 that is composed (e.g., written or recorded) in the graph representation language 145. This generation is performed by LLM 125 in response to the prompt 135. Here, LLM 125 is configured to derive graph representation language 145 from the infrastructure requirements 165.

Specification generator 155 is configured to convert the infrastructure topology 175 into an executable deployment specification 180 based on the manifest 170. Orchestration engine 160 is configured to execute the deployment specification to automatically configure 185 a target computing system 190 to have the compute infrastructure that is described by the infrastructure requirements 165.

In one embodiment, the components of variable GRL generation system 100 and of variable GRL infrastructure design system 150, and target computing system 190 intercommunicate in a network computing system, for example by electronic messages, as discussed below under the heading “Cloud or Enterprise Embodiments.”

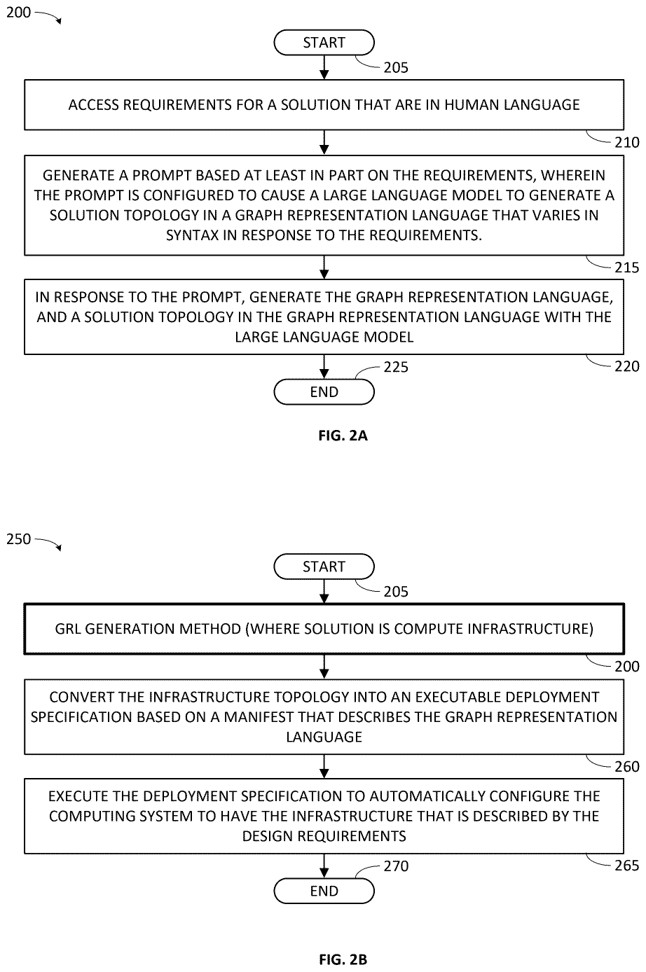

Further details regarding variable GRL generation system 100 are presented herein. In one embodiment, operations of variable GRL generation system 100 will be described with reference to variable GRL generation method 200 of FIG. 2A. In one embodiment, operations of variable GRL generation system 100 in the context of variable GRL infrastructure design system 150 will be described with reference to variable GRL infrastructure design method 250 of FIG. 2B.

### Example GRL Generation Method

FIG. 2A illustrates one embodiment of a variable GRL generation method 200 that is associated with design of infrastructures and other solutions by LLM using a variable syntax for graphs. In one embodiment, as a general overview, variable GRL generation method 200 accesses requirements for a solution. The requirements are in human language. variable GRL generation method 200 generates a prompt using the requirements. The prompt is configured to cause a large language model to generate a solution topology. The prompt causes the solution topology to be generated in a graph representation language that varies in syntax with changes to the requirements. In response to the prompt, variable GRL generation method 200 generates, with the large language model, (1) the graph representation language and (2) the solution topology in the graph representation language.

In one embodiment, variable GRL generation method 200 initiates at START block 205 in response to variable GRL generation system 100 determining that one or more conditions or events have been detected or have occurred. The conditions or events for initiating variable GRL generation method 200, include, but are not limited to: (1) variable GRL generation system 100 has received an instruction to generate a solution topology from human language requirements for the solution; (2) variable GRL generation system 100 receives input of requirements for a solution; (3) a user or administrator has initiated variable GRL generation method 200; (4) it is currently a time at which variable GRL generation method 200 is scheduled to be run; or (5) some other condition for commencing variable GRL generation method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of variable GRL generation system 100 executes variable GRL generation method 200. In one embodiment, at START block 205, variable GRL generation system 100 configures compute resources for performing variable GRL generation method 200. (1) variable GRL generation system 100 provisions (i.e., allocates and initializes) resources of the computing system that are used by variable GRL generation system 100, such as processor, memory and storage (for example, for executing components of variable GRL generation system 100). (2) variable GRL generation system 100 establishes access to one or more networks for the resources, such as access to (a) internal networks for communication among components of variable GRL generation system 100 and (b) external networks for communication with other computing systems (for example, client systems, variable GRL infrastructure design system 150, or target computing system 190). (3) variable GRL generation system 100 connects to data sources (such as databases, data stores, file systems, and cloud storage) used by the variable GRL generation method 200. And, (4) variable GRL generation system 100 configures the computing system with system settings, software dependencies and libraries, and modules for executing the components of variable GRL generation system 100. Following initiation at START block 205, variable GRL generation method 200 proceeds to block 210.

At block 210, variable GRL generation method 200 accesses requirements for a solution that are in human language. The variable GRL generation method 200 gets a data structure (such as a file) that contains the requirements.

The infrastructure requirements are in human language, and might therefore be unstructured, or otherwise not follow a particular formal structure. In one embodiment, the requirements may be infrastructure requirements for a compute infrastructure.

Accessing the requirements may take a variety of forms. In one embodiment, a requirements intake handler of the variable GRL generation system includes an API endpoint for requesting generation of a solution topology and a GRL tailored to the solution topology. This GRL API endpoint accepts as input an API request that includes the requirements. The variable GRL generation method 200 parses requests received at the validation API endpoint to extract and store the requirements provided as input. In another embodiment, the requirements may be (A) provided in a file(s) located at a provided file path(s), (B) provided as one or more specified records in a database, or (C) received by input (e.g., upload) through a user interface.

In one embodiment, variable GRL generation method 200 access requirements for a solution that are in human language by listening at an API endpoint of the variable GRL generation method 200 for a request; in response to receiving a request, parsing the request to extract the infrastructure requirements; and storing the infrastructure requirements in a manner that makes them accessible for subsequent analysis.

In one embodiment, the steps of block 210 are performed by requirements handler 110. At the conclusion of block 210, variable GRL generation method 200 has obtained requirements from which a solution design may be automatically derived, and expressed in a GRL customized for use with the solution design. Processing continues to block 215.

At block 215, variable GRL generation method 200 generates a prompt based at least in part on the requirements. The prompt is configured to cause a large language model to generate a solution topology. The solution topology is to be generated in a graph representation language that is derived from the requirements. The graph representation language therefore varies in response to a change to the requirements. Variable GRL generation method 200 assembles the prompt from the infrastructure requirement that instructs an LLM to generates the solution topology in a custom GRL that conforms to the types of nodes and edges that are used in the solution topology.

In one embodiment, the prompt may include instructions in human language that direct an LLM to generate a solution topology, and to express the solution topology in a GRL that has the types of graph elements (nodes, edges) that are used in the solution topology.

In one embodiment, the variable GRL generation method 200 generates the prompt by inserting the requirements into a template prompt. The template prompt requests creation of the solution topology in a variable GRL derived from the requirements. For example, where the LLM is to generate a LST, the template prompt might be something like:
“Given the following requirements, generate a custom Graph Representation Language (GRL) that includes only the necessary node types and edge types to fully represent the requirements as a logical solution topology. Using the custom GRL, produce a logical solution topology that fully addresses the infrastructure requirements. Additionally, produce a manifest table that provides a description for each node type and edge type of the custom GRL.
Requirements: [Requirements]”

Or, in another example, where the LLM is to generate a PST, the template prompt might be something like:
“Given the following requirements and logical solution topology, generate a custom Graph Representation Language (GRL) that includes only the necessary node types and edge types to fully represent the requirements as a physical solution topology. The logical solution topology (LST) is written in another GRL for which the edge types and node types are defined by the following LST manifest. Using the custom GRL, produce a physical solution topology that both (1) fully addresses the requirements and (2) follows the logical structure described by the logical topology. Additionally, produce a manifest table that provides a description for each node type and edge type of the custom GRL.
Requirements: [Requirements]
Logical Solution Topology: [Logical_Solution_Topology]
LST Manifest: [Manifest]”

In one embodiment, the template prompts may include a further instruction to prioritize human-readable detail in the custom GRL to an extent designated by a verbosity hyperparameter. For example, the prompt may further include a sentence such as “Generate the GRL to have a verbosity of [Verbosity_Hyperparameter] on a scale of 0 to 1, with 0 being least verbose, and 1 being most verbose.”

In one embodiment, the template prompts may include a further exclusion instruction to exclude designated portions of the requirements from consideration by the LLM. For example, the prompt may further include a sentence such as “Apply the following exclusions to the requirements prior to generating the topology and GRL. Exclusions: [Exclusions]”

In one embodiment, the template prompts may include a further granularity instruction to replace an individual type of node or edge with a plurality of types in order to provide for more granular representation of topology elements. For example, the prompt may further include a sentence such as “Generate the GRL to have a discrete type of [Node/Edge] for each of the possible values of the [Property] of [Node/Edge].”

In one embodiment, variable GRL generation method 200 generating a prompt based at least in part on the requirements by the following steps. Variable GRL generation method 200 checks to determine whether the solution topology to be generated is an LST or a PST, for example based on whether an existing LST has been provided with the request for generation of a solution topology. Where there is no LST, an LST is to be generated. Where there is an LST, a PST is to be generated. Variable GRL generation method 200 loads a template prompt for a LST or PST, corresponding to the type of topology that is determined to be generated. The template prompt is configured to instruct an LLM to generate a solution topology in a custom GRL, and the GRL generated to have only those element and edge types needed to represent the solution. The infrastructure validation method 200 populates corresponding variable fields of the template prompt with current values for the infrastructure requirements, as well as values for any additional variables in the template prompt, such as a verbosity hyperparameter, an exclusion instruction, or a granularity instruction. These variables may be text strings. The variable GRL generation method 200 makes the populated template prompt available for use by downstream processes.

In one embodiment, the steps of block 215 are performed by prompt generator 115. At the conclusion of block 215, variable GRL generation method 200 has generated a prompt that is configured to trigger an LLM to represent a solution as a graph using a compact, custom GRL that is tailored to represent only those types of nodes and edges that are used in the solution. Processing continues to block 220.

At block 220, in response to the prompt, variable GRL generation method 200 generates the graph representation language and the solution topology in the graph representation language using the large language model. Variable GRL generation method 200 submits the prompt generated in block 215 to the LLM, and captures the response by the LLM. Variable GRL generation method 200 executes the prompt with the LLM to create both a GRL and a solution topology written in the GRL.

In one embodiment, variable GRL generation method 200 generates the graph representation language and the solution topology in the graph representation language with the large language model by the following process. Variable GRL generation method 200 places the prompt into an API call to the LLM. Variable GRL generation method 200 transmits the API call (including the prompt) to an input API endpoint of the LLM that is configured to accept input to the LLM. Variable GRL generation method 200 listens for the response to the prompt at an output API endpoint of the LLM that is configured to deliver output from the LLM. Variable GRL generation method 200 executes the LLM to process the prompt. The LLM examines the requirements provided in the prompt to determine what types of nodes and what types of edges are needed to represent a solution to the requirements as a topology. The LLM adds these types of nodes and types of edges to a manifest (e.g., a table) for the GRL, along with descriptions of these types of nodes and types of edges. The LLM composes a solution topology using these types of nodes and types of edges. The LLM returns the solution topology and manifest to the output API as its response to the prompt. Variable GRL generation method 200 listens at the output API endpoint for the response, and detects the arrival of the response at the output endpoint and stores the response in memory. Variable GRL generation method 200 parses the response to capture the solution topology and associated manifest describing the custom GRL that is tailored to the solution topology, based on the requirements. Variable GRL generation method 200 stores the solution topology and associated manifest, and makes them available for downstream processes.

In one embodiment, the steps of block 220 are performed by topology and GRL generator 120. At the conclusion of block 220, variable GRL generation method 200 has written a solution topology in a compact, custom fit GRL that has adjusted or varied to satisfy the requirements. Processing continues to END block 225, where (in one embodiment) variable GRL generation method 200 concludes.

Referring now to FIG. 2B, in one embodiment, variable GRL generation method 200 proceeds onward to the steps of a variable GRL infrastructure design method 250. Variable GRL infrastructure design method 250 is associated with design of infrastructures and other solutions by LLM using a variable syntax for graphs. In variable GRL infrastructure design method 250, the solution is compute infrastructure, and the solution topology is a PIT. Variable GRL infrastructure design method 250 operates to convert the PIT into an executable deployment specification, and execute the deployment specification to autonomously deploy compute infrastructure that satisfies the requirements into a target computing system.

At block 260, variable GRL infrastructure design method 250 converts the infrastructure topology into an executable deployment specification based on the manifest. Variable GRL infrastructure design method 250 uses the manifest to configure a specification generator to read the custom-generated GRL in which the PIT is written. For one or more (or each) of the node types and edge types in the manifest, variable GRL infrastructure design method 250 uses the description written in the manifest that corresponds to the type to identify constructs of configuration code that are analogous to the type.

In this context, the term “constructs” refers to elements or structures in the configuration code that are used for defining and configuring components of compute infrastructure. For example, where the orchestration engine (used in block 265 to execute the deployment specification) is Ansible, constructs may include playbooks, plays, tasks, roles, modules, variables, handlers, and so on. And, for example, where the orchestration engine is Terraform, constructs may include resource blocks, providers, data sources, modules, variables, output values, and so on.

In one embodiment, variable GRL infrastructure design method 250 may execute a program with specification generator 155. The program is configured to map elements of the PIT to constructs of the configuration code that are executable by the orchestration engine. For example, the mapping may be performed based on semantic similarity between the description of the topology element (node or edge) and the constructs. Or, in another example, the mapping may be performed based on pre-defined mapping rules that are associated with a standard set of descriptions that may be applied by the LLM.

In one embodiment, variable GRL infrastructure design method 250 may determine which construct(s) is semantically similar to the description. Constructs may include both human-readable code and human-language comments, providing a basis for semantic comparison. To perform the semantic comparison, the description from the manifest and the code and/or comments for a construct are embedded into respective vectors, and a cosine similarity is determined between the two vectors. When the cosine similarity between the two vectors satisfies a threshold, the construct is associated with the type of node or edge. The threshold may be, for example, close to 1, such as greater than 0.8 or 0.9, indicating a high degree of semantic similarity. This threshold may be adjusted so as to capture the relevant constructs. In one embodiment, where instances of the type of node or edge appear in the PIT, the construct is populated with corresponding parameters from the instance of node or edge, and added to the deployment specification until all instances of nodes and edges in the PIT are represented in by constructs in the deployment specification.

Or, in one embodiment, the LLM is trained to apply a standard set of descriptions to the node types and edge types. The standard descriptions are pre-defined to be associated with particular constructs. Where an instance of a type of node or edge appears in the PIT, the constructs associated with the type are retrieved, populated with the corresponding parameters from the instance of node or edge in the PIT, and added to the deployment specification until all instances of nodes and edges in the PIT are represented by constructs in the deployment specification.

In either case, constructs are added to the deployment specification as blocks of code configured to cause the orchestration engine to implement the element of the PIT that is associated with the construct. The code for the constructs is written into the deployment specification in an order that is appropriate for valid execution.

In one embodiment, the steps of block 260 are performed by specification generator 155. At the conclusion of block 260, variable GRL generation method 200 has created a deployment specification that can be executed to cause a target computing system to automatically create virtualized infrastructure that conforms to the infrastructure requirements. Processing continues to block 265.

At block 265, variable GRL generation method 200 executes the deployment specification to automatically configure a target computing system to have the compute infrastructure that is described by the requirements. For example, variable GRL generation method 200 inputs the deployment specification into an orchestration engine (e.g., Ansible or Terraform) to deploy compute infrastructure that is configured as shown by the PIT into the target computing system. In one embodiment, variable GRL generation method 200 parses the deployment specification to determine the declarations or sequence of actions for provisioning and configuring, in the target computing system, the infrastructure described by the PIT. Then, variable GRL generation method 200 executes the declarations or sequence of actions to provision and configure the infrastructure in the target computing system, and thereby launches a target computer system that is fully configured as specified by the human-language requirements.

In one embodiment, the steps of block 265 are performed by orchestration engine 160. At the conclusion of block 265, variable GRL generation method 200 has set up virtualized (e.g., cloud) computing hardware to operate according to the requirements. Processing continues to END block 270, where variable GRL generation method 200.

### Example Additional Features of Variable GRL Generation Method

In one embodiment, when the LLM generates the GRL (as discussed at block 220), the LLM includes a description of the syntax of the GRL in the response to the prompt. For example, the variable GRL generation method 200 generates a manifest with the LLM. The manifest defines the GRL, including a syntax of the GRL. The manifest includes an enumeration of node types and edge types along with corresponding descriptions of the node types and the edge types.

In one embodiment, the GRL is derived from the requirements. The GRL incorporates node types and edge types for entities and relationships (respectively) that occur in the requirements, while excluding, omitting, or otherwise not creating node or edge types for those entities and relationships that are not included in the requirements. Therefore, in one embodiment, when generating the GRL, the variable GRL generation method 200 defines node types to correspond to elements that are described in the requirements, and define edge types to correspond to connections or relationships that are described in the requirements. (Note, elements may not be expressly described in the requirements, and are rather derived from the requirements when the topology is generated.) And, in one embodiment, the variable GRL generation method 200 does not define node types corresponding to elements that are not in the requirements (or more particularly, elements that are not in the topology generated based on the requirements, consistent with the note above), and does not define edge types to correspond to connections or relationships that are not in the requirements. Thus, in one embodiment, node types and edge types are created in the GRL when they will be used in the solution topology, and are left out of the GRL where the types will not be used in the solution topology. In one embodiment, properties of the node types and edge types may similarly be included in the GRL when they appear in the requirements, and excluded from the GRL when they do not occur in the requirements.

In one embodiment, generation of the manifest that defines the graph representation language includes defining node types to correspond to elements that are described in the requirements; and defining edge types to correspond to connections that are described in the requirements.

In one embodiment, variable GRL generation method 200 may generate a solution topology for a subset of the requirements, thus generating the solution topology from a selected portion of the requirements while disregarding another, unselected portion of the requirements. In one embodiment, the variable GRL generation method 200 accepts an instruction to disregard a portion of the requirements. (Note, the instruction to disregard the portion may be posed as an instruction to consider a complementary portion of the requirements.) And, in response to the instruction to disregard the portion of the requirements, the variable GRL generation method 200 excludes the portion of the requirements from inclusion in the prompt. The instruction to disregard the portion may be included in the requirements, or may be provided in addition to the requirements, for example by a user-input of the instruction, or by retrieval of a pre-specified instruction from storage.

In one embodiment, the variable GRL generation method 200 may be instructed to increase granularity of entity (node) types and/or relationship (edge) types in the syntax of the generated GRL. For example, variable GRL generation method 200 may be instructed to assign distinct types of nodes for servers with differing operating systems, rather than leaving operating system as a variable property of a single type of node. Thus, in one embodiment, the variable GRL generation method 200 accepts an instruction to replace either: (1) a particular type of node with a plurality of types of node; or (2) a particular type of edge with a plurality of types of edge; and indicate the instruction in the prompt. The instruction to replace the single type with the plurality of types may be included in the requirements, or may be provided in addition to the requirements, for example by a user-input of the instruction, or by retrieval of a pre-specified instruction from storage.

As discussed above with reference to FIG. 2B, where the solution topology is a compute infrastructure topology, the compute infrastructure topology may be translated into code for configuring a cloud computing system to have the compute infrastructure, and the code executed to automatically create the compute infrastructure. For example, where the solution topology is a compute infrastructure topology, variable GRL generation method 200 converts the solution topology to an executable deployment specification. Then, variable GRL generation method 200 executes the deployment specification with an orchestration engine to configure a target computer system. The configuration by the orchestration engine causes the target computer system to have compute infrastructure that is consistent with the compute infrastructure topology, and furthermore that complies with the requirements.

In one embodiment, variable GRL generation method 200 controls a balance between brevity and detail in the generated GRL. The balance is controlled by pre-specifying a value for verbosity of the GRL, and including this hyperparameter in the prompt to the LLM. Thus, in one embodiment, when generating the prompt, variable GRL generation method 200 specifies a verbosity hyperparameter in the prompt. For example, variable GRL generation method 200 includes a hyperparameter in the prompt that indicates to what extent the graph representation is to be verbose. Variable GRL generation method 200 then generates the graph representation language to prioritize human-readability of the graph representation language in proportion to the hyperparameter.

A more verbose GRL syntax more closely resembles human language and common mathematical notion, prioritizing human-readability over efficiency of representation. A more verbose GRL also gives types of nodes, types of edges, and their respective parameters descriptive names that convey their purpose. A more concise GRL syntax less closely resembles human language, prioritizing compact representation over self-explanation. The hyperparameter for verbosity may be defined on a scale, where one end of the scale represents highly descriptive, detailed syntax for the GRL, and the other end of the scale represents highly concise, minimalistic syntax for the GRL. For example, the verbosity hyperparameter example may be defined on a scale between 1 for maximal verbosity (minimal conciseness) and 0 for minimal verbosity (maximal conciseness). (As used herein, “verbose” is a converse of “concise”). During a training phase, the LLM may be exposed to examples of GRL syntax that vary in verbosity, and which are labeled with hyperparameter values on the scale between verbose and concise. The LLM learns to associate levels of the verbosity hyperparameter with corresponding levels of detail of GRL syntax.

In one embodiment, generation of the infrastructure topology follows a two-phase process. For example, when generating the infrastructure topology in the graph representation language (as discussed at block 220) variable GRL generation method 200 generates an intermediate LIT in an intermediate GRL. The intermediate LIT and GRL are generated based on the requirements. Then, variable GRL generation method 200 generates the infrastructure topology in the GRL based on the LIT, the intermediate GRL, and the requirements. Here, the infrastructure topology is a PIT.

### Discussion of Variable GRL Generation

As discussed above, the variable GRL generation systems and methods described herein provides variable graph syntax using LLM-generated GRLs. The variable GRL generation systems and methods described herein improve the technology of graph representation by providing a variable graph syntax for GRLs. Introduction of variable graph syntax enables GRLs to be driven by—and specifically adapted to—the underlying solution the GRL is being used to represent as a graph. This allows the GRL to be compact, saving substantial overhead.

In prior solutions, the syntax of the graph specification was always predetermined and fixed. E.g., for infrastructure there are a predetermined set of types of nodes (such as nodes for VM (virtual machine), LBR (load balancer), router, switch, etc.) and two types of edges (direct plug connection and network connection). More generally for solution graphs, there is a solution-specific fixed set of types of nodes and edges.

However, depending on circumstances, it may be advantageous to: (1) ignore certain aspects of a solution, resulting in some node/edge types in the graph representation language to never be used; or (2) further refine certain types of entities or interactions, resulting in some individual node/edge types being replaced with a plurality (or set or collection) of nodes/edge types, e.g., it may be beneficial to differentiate between Linux and Windows servers at the node level.

Accordingly, instead of predefining the graph node and edge types, the variable GRL generation system employs an LLM to generate the graph language (including types of nodes and edges) that would be used to describe a topology of a solution. For example, for infrastructure LIT (logical infrastructure topology) and PIT (physical infrastructure topology) generation, the LLM defines the nodes corresponding to the content of the infrastructure and edges corresponding to the possible connections. More generally, for solution LST (logical solution topology) and PST (physical solution topology) generation, the LLM defines the graph elements that are pertinent to the types of solutions. Not all solutions have all the possible solution elements.

In addition to the topology output (graphs), the LLM produces a manifest (or key) that explains the graph specification language used to create the topology. The manifest describes how the GRL is to be interpreted. The manifest enumerates the types of nodes and edges, and stating the meanings/purposes of the node and edge types. The manifest may be read by downstream processes and used to interpret the topologies. For example, for infrastructure LIT and PIT generation, the LLM defines the nodes corresponding to the content of the infrastructure and edges, corresponding to the connections that are possible in the infrastructure. Similarly, for solution LST and PST generation, the LLM would define the graph elements pertinent to the types of solutions (not all solutions include all the possible solution elements).

In another example, in general, graph representative language (GRL) is a general syntax of a language. The actual set of entities represented by a particular instance of GRL generated by the LLM is defined by the manifest. E.g., GRL syntax includes a node and an edge. The LIT calls for 2 types of edges and 3 types of nodes. So, the manifest will include edge 0, edge 1, node 0, node 1, node 2. Thus, the manifest defines the graph representation language.

The variable GRL generation systems and methods find one example application in automated infrastructure and solution design using an LLM. Note that the applicability of the variable GRL generation systems and methods is broader than IT infrastructure and generally applicable for solution design in many fields, including manufacturing (e.g., bill of material (BOM) processing), chemical, pharmaceutical, medical, etc.

Thus, in one embodiment, the variable GRL generation systems and methods use an LLM to develop a GRL that is specifically tailored to the content of a requirements document. This tailored approach ensures the generated GRL provides what is needed to represent a particular solution without excess complexity. Simplifying the GRL makes it easier to manage and process. Where a pre-defined GRL contains hundreds of elements while only a few are used, reducing the GRL to those few relevant elements reduces the processing load and potential for error. A simpler graph language is easier for systems that ingest and process the graph data to understand. This can improve system efficiency and reduce errors in data interpretation.

A tailored GRL produced by the variable GRL generation systems and methods allows for improved flexibility and interoperability, enabling various systems to easily ingest and utilize the graph data based on the provided grammar. For example, a simplified and tailored GRL aids in interoperability between different systems or LLMs, particularly when these systems need to share or process a set of graphical data. And, the flexibility of the variable GRL generation systems and methods to produce GRLs that are specific to a specified solution (for example as provided in a requirements document) allows the foregoing advantages and improvements to be applicable across a wide variety of technical domains, such as IT, materials and manufacturing, chemical processing, medicine, construction, and so on.

The verbosity or conciseness of the generated GRL may be controlled through one or more hyperparameters provided to the LLM. This allows for fine-tuning the output to meet specific needs, enhancing both the utility and the usability of the generated graph language. For example, a user may specify a value on a predefined spectrum between verbose and concise, which will cause the LLM to produce a more detailed or streamlined (respectively) GRL. In one embodiment, the LLM is specially trained to produce GRL with higher levels of detail where the value of the verbosity-conciseness hyperparameter indicates greater verbosity and less conciseness, and to produce GRL with lower levels of detail where the value of the verbosity-conciseness hyperparameter indicates less verbosity and greater conciseness. In one embodiment, the verbosity-conciseness hyperparameter is a value between 1 indicating maximum verbosity and minimum conciseness, and 0 indicating minimum verbosity and maximum conciseness.

### Further Example of Variable GRL Generation Method

One example of variable GRL generation method follows. The example method accesses—for example, receives as input—infrastructure requirements. The infrastructure requirements describe features or functions of a compute infrastructure. The requirements are written in human language. If instructed to do so by the infrastructure requirements or other input, the example method may exclude one or more portions of the infrastructure requirements from further processing, proceeding instead with a subset of the infrastructure requirements. Also, if instructed to do so by the infrastructure requirements or other input, the example method may specify that one or more entities or relationships in the infrastructure requirements are to be represented with enhanced granularity of type, with multiple types of node or edge representing discrete values of a property for the entity or relationship.

The example method then performs a two-stage process for generation of an infrastructure topology: a first stage in which an intermediate LIT is generated, and a second stage in which a final PIT is generated. In the first stage, the example method composes a first prompt to an LLM. The first prompt is based on the infrastructure requirements. And, the first prompt is based on a first exclusion instruction, if any, to exclude portions of the infrastructure requirements from consideration by the LLM. Also, the first prompt is based on a first granularity instruction, if any, to increase granularity of representation of one (or more) logical entity or relationship.

The first prompt is configured to elicit a LIT from the LLM that satisfies the infrastructure requirements. The first prompt is configured to cause the LLM to generate a first GRL specifically for expressing the LIT. The first GRL is derived from the infrastructure requirements. The first GRL includes types of nodes and types of edges used for logical representation in the LIT of the entities and relationships that are indicated by the infrastructure requirements. The first GRL does not include types of nodes or edges which are not used in the LIT generated by the LLM. The first prompt may include a first verbosity hyperparameter that is configured to control the extent to which the LLM favors a descriptive syntax for the first GRL or a minimalistic syntax for the first GRL. The first prompt may be generated by populating appropriate variables of a template prompt with (1) the infrastructure requirements (as modified by the first exclusion instruction, if any, to remove some portion of the infrastructure requirements), (2) the first granularity instruction, if any, and (3) the first verbosity hyperparameter.

The example method submits the first prompt to the LLM, and captures the response. Receipt of the prompt triggers the LLM to execute the prompt. The LLM generates the first GRL, and a LIT written using the first GRL. For example, the LLM generates a first manifest that lists the node types and edge types that are included in the first GRL, along with respective descriptions of the included node types and edge types. The first GRL may vary in syntax based on the content of the infrastructure requirements. In this example, the first GRL has only those node types and edge types that are used in the LIT.

In the second stage, the example method composes a second prompt to the LLM. The second prompt is based on the infrastructure requirements, the LIT and corresponding GRL. And, the second prompt is based on a second exclusion instruction, if any, to exclude portions of the infrastructure requirements from consideration by the LLM. The second exclusion instruction may exclude the same portion of the infrastructure requirements as was excluded by the first exclusion instruction. Or, the second exclusion instruction may exclude a different portion of the infrastructure requirements from that portion excluded by the first exclusion instruction. Also, the second prompt is based on a second granularity instruction, if any, to increase granularity of representation of one (or more) physical entity or relationship.

The second prompt is configured to elicit a PIT from the LLM that satisfies the infrastructure requirements. The second prompt is configured to cause the LLM to generate a second GRL specifically for expressing the PIT. The second GRL is derived from the infrastructure requirements. The second GRL includes types of nodes and types of edges used for physical representation in the PIT of the entities and relationships that are indicated by the infrastructure requirements. The second GRL does not include types of nodes or edges which are not used in the PIT generated by the LLM. The second prompt may include a second verbosity hyperparameter that is configured to control the extent to which the LLM favors a descriptive syntax for the second GRL or a minimalistic syntax for the second GRL. The second prompt may be generated by populating appropriate variables of a template prompt with (1) the infrastructure requirements (as modified by the second exclusion instruction, if any, to remove some portion of the infrastructure requirements), (2) the LIT and the first manifest, (3) the second granularity instruction, if any, and (4) the second verbosity hyperparameter.

The example method submits the second prompt to the LLM, and captures the response. Receipt of the second prompt triggers the LLM to execute the second prompt. The LLM reads the infrastructure requirements and second granularity instruction, and parses the LIT in accordance with the first manifest. (Note, in one embodiment, the LIT is generated before a PIT, so the first manifest is associated with the LIT.) The LLM then generates the second GRL, and a PIT written using the second GRL. The PIT has a logical structure that follows the LIT, although the PIT further specifies the physical components for implementation of the compute infrastructure. The LLM generates a second manifest that lists the node types and edge types that are included in the second GRL, along with respective descriptions of the included node types and edge types. The second GRL may vary in syntax based on the content of the infrastructure requirements. Note also that the second GRL may vary in syntax from the first GRL. In this example, the second GRL has only those node types and edge types that are used in the PIT.

The example method then converts the PIT into an executable deployment specification. The conversion is based, at least in part, on the second manifest. The example method configures the specification generator using the contents of the second manifest. The configuration maps node and edge types (and their associated properties) to configuration code. The mapping is based on similarity (or matching) between the descriptions in the second manifest and analogous constructs in the configuration code. The mapping may involve semantic analysis and/or pre-defined mapping rules between the descriptions in the second manifest and the various constructs. Once the analogous constructs are identified for the node types and edge types in the second manifest, the example method configures the specification generator to convert the nodes and edges in the PIT to instances of their respective analogous constructs.

The collective instances of the analogous constructs form a body of configuration code. The example method executes the configuration code using an orchestration engine that is compatible with the configuration code. The orchestration engine configures a target computing environment (e.g., a virtualized computing system) in accordance with the configuration code. This causes the target computing environment to have the physical infrastructure described by the PIT, and which satisfies the infrastructure requirements. The target computing environment launches and operates the compute infrastructure.

### Cloud or Enterprise Embodiments

In one embodiment, the present system (such as variable GRL generation system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, variable GRL generation system 100 is a centralized server-side application that provides at least the functions disclosed herein and that is accessed by many users by way of computing devices/terminals communicating with the computers of variable GRL generation system 100 (functioning as one or more servers) over a computer network. In one embodiment variable GRL generation system 100 may be implemented by a server or other computing device configured with hardware and software to implement the functions and features described herein.

In one embodiment, the components of variable GRL generation system 100 may be implemented as sets of one or more software modules executed by one or more computing devices specially configured for such execution. In one embodiment, the components of variable GRL generation system 100 are implemented on one or more hardware computing devices or hosts interconnected by a data network. For example, the components of variable GRL generation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of variable GRL generation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of variable GRL generation system 100 may (i) generate or compose an electronic message or signal to issue a command or request to another component, (ii) transmit the message or signal to other components of variable GRL generation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by variable GRL generation system 100, for example through a web interface server. In one embodiment, the remote computing system may send requests to and receive responses from variable GRL generation system 100. In one example, access to the information or applications may be effected through use of a web browser on a personal computer or mobile device. In one example, communications exchanged with variable GRL generation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of variable GRL generation system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, variable GRL generation systems and methods described herein may be implemented by using a computer program product, comprising computer program/instructions which, when executed by a processor, cause the processor to perform any of the methods described in the disclosure.

### Computing Device Embodiment

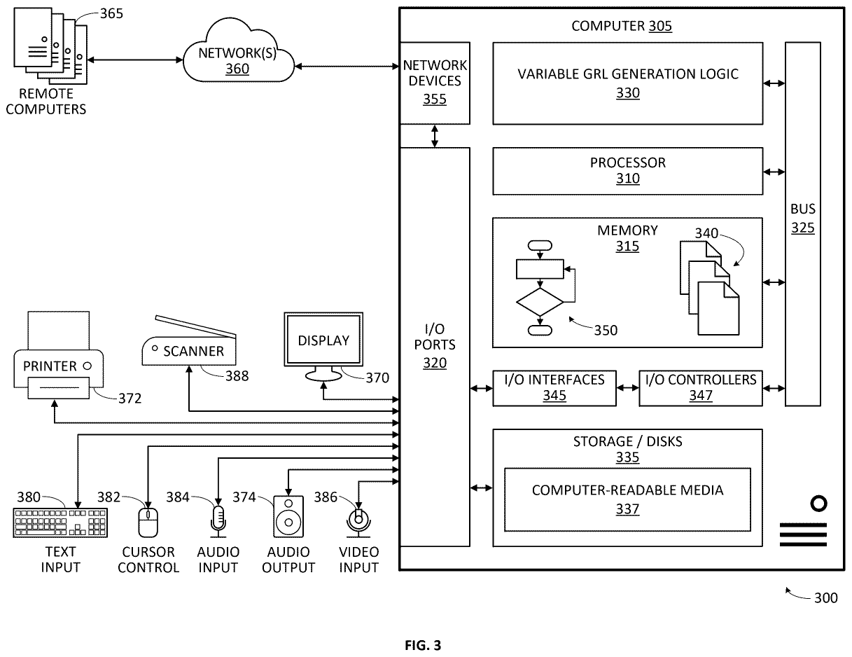

FIG. 3 illustrates an example computing system 300 that is configured and/or programmed as a special purpose computing device(s) with one or more of the example systems and methods described herein, and/or equivalents. The example computing device may be a computer 305 that includes at least one hardware processor 310, a memory 315, and input/output ports 320 operably connected by a bus 325. In one example, the computer 305 may include variable GRL generation logic 330 configured to facilitate design of infrastructures and other solutions by LLM using a variable syntax for graphs, similar to the logic, methods, and systems described above and/or shown in and described with reference to FIGS. 1A, 1B, 2A, and 2B.

In different examples, the logic 330 may be implemented in hardware, one or more non-transitory computer-readable media 337 with stored instructions, firmware, and/or combinations thereof. While the logic 330 is illustrated as a hardware component attached to the bus 325, it is to be appreciated that in other embodiments, the logic 330 could be implemented in the processor 310, stored in memory 315, or stored in disk 335.

In one embodiment, logic 330 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate design of infrastructures and other solutions by LLM using a variable syntax for graphs. The means may also be implemented as stored computer executable instructions that are presented to computer 305 as data 340 that are temporarily stored in memory 315 and then executed by processor 310.

Logic 330 may also provide means (e.g., hardware, non-transitory computer-readable medium that stores executable instructions, firmware) for performing one or more of the disclosed functions and/or combinations of the functions.

Generally describing an example configuration of the computer 305, the processor 310 may be a variety of various processors including dual microprocessor and other multi-processor architectures. A memory 315 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 335 may be operably connected to the computer 305 via, for example, an input/output (I/O) interface (e.g., card, device) 345 and an input/output port 320 that are controlled by at least an input/output (I/O) controller 347. The disk 335 may be, for example, a magnetic disk drive, a solid-state drive, a floppy disk drive, a tape drive, a Zip drive, a flash memory card, a memory stick, and so on. Furthermore, the disk 335 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 315 can store a process 350 and/or a data 340, for example. The disk 335 and/or the memory 315 can store an operating system that controls and allocates resources of the computer 305.

The computer 305 may interact with, control, and/or be controlled by input/output (I/O) devices via the input/output (I/O) controller 347, the I/O interfaces 345, and the input/output ports 320. Input/output devices may include, for example, one or more network devices 355, displays 370, printers 372 (such as inkjet, laser, or 3D printers), audio output devices 374 (such as speakers or headphones), text input devices 380 (such as keyboards), cursor control devices 382 for pointing and selection inputs (such as mice, trackballs, touch screens, joysticks, pointing sticks, electronic styluses, electronic pen tablets), audio input devices 384 (such as microphones or external audio players), video input devices 386 (such as video and still cameras, or external video players), image scanners 388, video cards (not shown), disks 335, and so on. The input/output ports 320 may include, for example, serial ports, parallel ports, and USB ports.

The computer 305 can operate in a network environment and thus may be connected to the network devices 355 via the I/O interfaces 345, and/or the I/O ports 320. Through the network devices 355, the computer 305 may interact with a network 360. Through the network 360, the computer 305 may be logically connected to remote computers 365. Networks with which the computer 305 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
access requirements for a solution that are in human language;
generate a prompt based at least in part on the requirements, wherein the prompt is configured to cause a large language model to generate a solution topology in a graph representation language that is derived from the requirements; and
in response to the prompt, generate the graph representation language, and the solution topology in the graph representation language with the large language model.

2. The non-transitory computer-readable media of claim 1, further comprising instructions that when executed by at least the processor cause the computing system to generate a manifest with the large language model, wherein the manifest defines the graph representation language, wherein the manifest includes an enumeration of node types and edge types and corresponding descriptions of the node types and the edge types.

3. The non-transitory computer-readable media of claim 1, wherein the instructions to generate the graph representation language further cause the computing system to:
define node types to correspond to elements that are described in the requirements; and
define edge types to correspond to connections that are described in the requirements.

4. The non-transitory computer-readable media of claim 1, further comprising instructions that when executed by at least the processor cause the computing system to:
accept an instruction to disregard a portion of the requirements; and
exclude the portion of the requirements from inclusion in the prompt.

5. The non-transitory computer-readable media of claim 1, further comprising instructions that when executed by at least the processor cause the computing system to:
accept an instruction to replace either (1) a particular type of node with a plurality of types of node or (2) a particular type of edge with a plurality of types of edge; and
indicate the instruction in the prompt.

6. The non-transitory computer-readable media of claim 1, wherein the solution topology is a compute infrastructure topology, the instructions further comprising:
convert the solution topology to an executable deployment specification; and
execute the deployment specification with an orchestration engine to configure a target computer system to have compute infrastructure that is consistent with the compute infrastructure topology.

7. The non-transitory computer-readable media of claim 1, wherein the instructions to generate the prompt further cause the computing system to specify a verbosity hyperparameter in the prompt.

8. A computer-implemented method, comprising:
accessing requirements for a solution that are in human language;
generating a prompt based at least in part on the requirements, wherein the prompt is configured to cause a large language model to generate a solution topology in a graph representation language that varies in syntax in response to a change to the requirements; and
in response to the prompt, generating the graph representation language, and the solution topology in the graph representation language with the large language model.

9. The computer-implemented method of claim 8, further comprising generating a manifest with the large language model, wherein the manifest defines the graph representation language, wherein the manifest includes an enumeration of node types and edge types and corresponding descriptions of the node types and the edge types.

10. The computer-implemented method of claim 8, wherein generating the graph representation language further comprises:
defining node types to correspond to elements that are described in the requirements; and
defining edge types to correspond to connections that are described in the requirements.

11. The computer-implemented method of claim 8, further comprising:
accepting an instruction to disregard a portion of the requirements; and
excluding the portion of the requirements from inclusion in the prompt.

12. The computer-implemented method of claim 8, further comprising:
accepting an instruction to replace either (1) a particular type of node with a plurality of types of node or (2) a particular type of edge with a plurality of types of edge; and
indicating the instruction in the prompt.

13. The computer-implemented method of claim 8, wherein the solution topology is a compute infrastructure topology, further comprising:
converting the solution topology to an executable deployment specification based on definitions of those node types and edge types that occur in the requirements; and
executing the deployment specification with an orchestration engine to configure a target computer system to have compute infrastructure that is consistent with the compute infrastructure topology.

14. The computer-implemented method of claim 8, further comprising specifying a verbosity hyperparameter in the prompt.

15. A computing system, comprising:
at least one processor connected to at least one memory;
one or more non-transitory computer-readable media that include stored thereon computer-executable instructions that when executed by at least a processor of a computing system cause the computing system to:
access requirements for a compute infrastructure that are in human language;
generate a prompt based at least in part on the requirements, wherein the prompt is configured to cause a large language model to generate an infrastructure topology in a graph representation language that is derived from the requirements;
in response to the prompt, generate with the large language model:
(1) a manifest that defines the graph representation language, and
(2) the infrastructure topology in the graph representation language;
convert the infrastructure topology into an executable deployment specification based on the manifest; and
execute the deployment specification to automatically configure a target computing system to have the compute infrastructure that is described by the requirements.

16. The computing system of claim 15, wherein the instructions to generate the manifest that defines the graph representation language, when executed by at least the processor, further cause the computing system to:
define node types to correspond to elements that are described in the requirements; and
define edge types to correspond to connections that are described in the requirements.

17. The computing system of claim 15, wherein the instructions that when executed by at least the processor further cause the computing system to:
accept an instruction to disregard a portion of the requirements; and
exclude the portion of the requirements from inclusion in the prompt.

18. The computing system of claim 15, wherein the instructions that when executed by at least the processor further cause the computing system to:
accept an instruction to replace either (1) a particular type of node with a plurality of types of node or (2) a particular type of edge with a plurality of types of edge; and
indicate the instruction in the prompt.

19. The computing system of claim 15, wherein the computer-executable instructions, when executed by at least the processor, further cause the computing system to:
include a hyperparameter in the prompt that indicates to what extent the graph representation language is to be verbose; and
generate the graph representation language to prioritize human-readability of the graph representation language in proportion to the hyperparameter.

20. The computing system of claim 15, wherein the computer-executable instructions to generate the infrastructure topology in the graph representation language, when executed by at least the processor, further cause the computing system to:
generate an intermediate logical infrastructure topology in an intermediate graph representation language based on the requirements; and
generate the infrastructure topology in the graph representation language based on the intermediate logical infrastructure topology, the intermediate graph representation language, and the requirements, wherein the infrastructure topology is a physical infrastructure topology.
